(19) United States
(12) Patent Application Publication
(10) Pub. No.: US 2026/0215508 A1
(43) Pub. Date: Jul. 30, 2026

(54) ATOMIZATION ASSEMBLY, ATOMIZER, AND ELECTRONIC ATOMIZATION DEVICE

(71) Applicant: SHENZHEN FIRST UNION TECHNOLOGY CO., LTD., Shenzhen, Guangdong (CN)

(72) Inventors: Yongqiang LIU, Shenzhen, Guangdong (CN); Yuanqiu XIE, Shenzhen, Guangdong (CN); Baofeng XIE, Shenzhen, Guangdong (CN); Ruilong HU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/144,450

(22) PCT Filed: Dec. 12, 2023
(86) PCT No.: PCT/CN2023/138223

§ 371 Date: Jun. 27, 2025

(30) Foreign Application Priority Data
Dec. 28, 2022 (CN) 202211707849.3

(51) Int. Cl. A24F 40/465; A24F 40/10; A24F 40/44; A24F 40/48; A24F 40/57; H05B 3/26

(52) U.S. Cl. CPC A24F 40/465; A24F 40/10; A24F 40/44; A24F 40/48; A24F 40/57; H05B 3/26

(57) ABSTRACT

An atomization assembly, an atomizer, and an electronic atomization device. The atomization assembly includes: a support, configured to be of a tubular structure having openings in two ends, an liquid inlet being provided in a side wall of the support; a heating element, accommodated inside the support, the heating element including a first surface and a second surface opposite to the first surface; an liquid substrate being able to flow into the first surface through the liquid inlet; at least a part of an airflow channel being defined between the second surface and an inner surface of the support; and a heat insulation member, accommodated inside the support and at least partially arranged between the heating element and the inner surface of the support.

### CROSS-REFERENCE TO RELATED APPLICATIONS

This application claims priority to Chinese Patent Application No. 2202211707849.3, filed with China National Intellectual Property Administration on Dec. 28, 2022 and entitled “ATOMIZATION ASSEMBLY, ATOMIZER, AND ELECTRONIC ATOMIZATION DEVICE”, which is incorporated herein by reference in its entirety.

### TECHNICAL FIELD

The present application relates to the field of electronic atomization technologies, and in particular, to an atomization assembly, an atomizer, and an electronic atomization device.

### BACKGROUND

An electronic atomization device is an electronic product that generates an aerosol by atomizing a liquid substrate for a user to inhale, which generally includes two parts: an atomizer and a power supply assembly. The liquid substrate and a heating element for atomizing the liquid substrate are arranged inside the atomizer. The power supply assembly includes a battery and a circuit board.

In the existing electronic atomization device, the heating element is supported through a support, and heat of the heating element is easily conducted to the support. On the one hand, heat loss of the heating element is caused, and on the other hand, a temperature of another component unfavorably increases.

### SUMMARY

An aspect of the present application provides an atomization assembly, including:
a support, configured to be of a tubular structure having an air inlet and an air outlet, a liquid inlet being provided in a side wall of the support;
a heating element, accommodated inside the support, the heating element including a first surface and a second surface opposite to the first surface; the liquid inlet being configured to allow a liquid substrate to flow into the first surface, to cause the heating element to heat the liquid substrate and generate an aerosol; an airflow channel being defined between the second surface and an inner surface of the support, so that air flows in from the air inlet of the support and flows out from the air outlet of the support through the airflow channel; and
a heat insulation member, accommodated inside the support, at least a part of the heat insulation member being arranged between the heating element and the inner surface of the support to separate the heating element from the support.

Another aspect of the present application provides an atomization assembly, including:
a support, configured to be of a tubular structure having openings in two ends, a liquid inlet being provided in a side wall of the support, an accommodating cavity communicated with the liquid inlet and an airflow channel communicated with the accommodating cavity being formed in the support, air flowing in from an opening in one end of the support and flowing out from an opening in the other end of the support through the airflow channel;
a heating element, a liquid substrate being able to flow into the heating element through the liquid inlet, to cause the heating element to heat the liquid substrate and generate an aerosol;
a liquid transfer unit, in contact with the heating element, the liquid transfer unit being configured to: extract the liquid substrate flowing in from the liquid inlet and transfer the extracted liquid substrate to the heating element, where the heating element is located between the airflow channel and the liquid transfer unit; and
a heat insulation member, configured to hold the heating element and the liquid transfer unit, so as to be assembled into the accommodating cavity together with the heating element and the liquid transfer unit, where at least a part of the heat insulation member is arranged between the heating element and an inner surface of the support to provide separation.

Another aspect of the present application provides an atomizer, including:
a housing assembly, having a liquid storage cavity for storing a liquid substrate,
the housing assembly including a first part and a second part which are longitudinally arranged, a first part liquid storage cavity being defined inside the first part, and a radial size of the second part being less than a radial size of the first part; and,
the atomization assembly, at least a part of the atomization assembly being accommodated in the second part.

Another aspect of the present application provides an atomizer, including:
a housing assembly, having a liquid storage cavity for storing a liquid substrate, the housing assembly including a first part and a second part which are longitudinally arranged, a first part liquid storage cavity being defined inside the first part, and a radial size of the second part being less than a radial size of the first part;
a heating element, configured to heat a part of the liquid substrate to generate an aerosol;
a liquid transfer unit, in contact with the heating element, the heating element and the liquid transfer unit being arranged in a longitudinal direction of the housing assembly and dividing the second part to form an airflow channel and a second part liquid storage cavity; and
a support, configured to hold the heating element and the liquid transfer unit inside the second part,
where a part of a surface of the liquid transfer unit defines a boundary of the second part liquid storage cavity, and the second part liquid storage cavity is in flow communication with the first part liquid storage cavity; and a part of a surface of the heating element defines a boundary of the airflow channel, and the airflow channel provides a path through which the aerosol flows.

Another aspect of the present application further provides an electronic atomization device, including the atomizer and a power supply assembly detachably connected to the atomizer, where the heating element is configured to generate heat under penetration of a changing magnetic field; and
the power supply assembly includes:
a receiving part, configured to receive at least a part of the second part; and
a magnetic field generator, configured to generate a changing magnetic field under alternating current, the magnetic field generator is arranged close to the receiving part.

According to the atomization assembly, the atomizer, and the electronic atomization device, the heat insulation member and the heating element are both accommodated inside the support, and the heat insulation member is arranged between the heating element and the inner surface of the support. In this way, on the one hand, heat of the heating element can be prevented from being conducted to the support; and on the other hand, it is convenient to assemble components such as the heat insulation member, the heating element, and the support into the atomizer.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of an electronic atomization device according to an implementation of the present application.

FIG. 2 is a schematic exploded view of an electronic atomization device according to an implementation of the present application.

FIG. 3 is a schematic exploded view of an atomizer according to an implementation of the present application.

FIG. 4 is a schematic cross-sectional view of an atomizer according to an implementation of the present application.

FIG. 5 is a schematic exploded view of an atomization assembly according to an implementation of the present application.

FIG. 6 is a schematic diagram of a bottom base according to an implementation of the present application.

FIG. 7 is a schematic cross-sectional view of a bottom base according to an implementation of the present application.

FIG. 8 is a schematic exploded view of another atomization assembly according to an implementation of the present application.

FIG. 9 is a schematic exploded view of some elements in another atomization assembly according to an implementation of the present application.

FIG. 10 is a schematic diagram of still another atomization assembly according to an implementation of the present application.

FIG. 11 is a schematic exploded view of yet another atomization assembly according to an implementation of the present application.

FIG. 12 is a schematic exploded view of some elements in still another atomization assembly according to an implementation of the present application.

FIG. 13 is a schematic exploded view of a still yet another atomization assembly according to an implementation of the present application.

FIG. 14 is a schematic cross-sectional view of a power supply assembly according to an implementation of the present application.

FIG. 15 is a schematic diagram of a lower housing according to an implementation of the present application.

FIG. 16 is a schematic diagram of a lower support according to an implementation of the present application.

FIG. 17 is a schematic diagram of a base according to an implementation of the present application.

FIG. 18 is a schematic diagram of a magnetic field generator according to an implementation of the present application.

FIG. 19 is a schematic cross-sectional view of a magnetic field generator according to an implementation of the present application.

### DETAILED DESCRIPTION

To facilitate the understanding of the present application, the present application is described in more detail below with reference to accompanying drawings and specific implementations. It should be noted that, when an element is expressed as “being fixed to” another element, the element may be directly on the another element, or one or more intermediate elements may exist between the element and the another element. When one component is expressed as “being connected to” another component, the component may be directly connected to the another component, or one or more intermediate components may exist between the component and the another component.

The terms “upper”, “lower”, “left”, “right”, “inner”, “outer”, and similar expressions used in this specification are only used for an illustrative purpose.

Unless otherwise defined, meanings of all technical and scientific terms used in this specification are the same as those usually understood by a person skilled in the technical field to which the present application belongs. Terms used in this specification of the present application herein are merely intended to describe objectives of the specific implementations, but are not intended to limit the present application. A term “and/or” used in this specification includes any or all combinations of one or more related listed items.

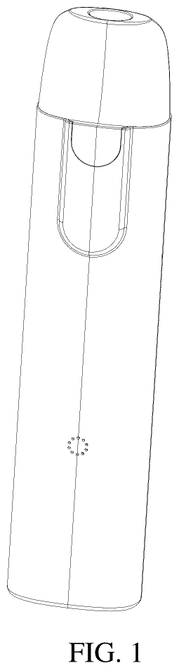

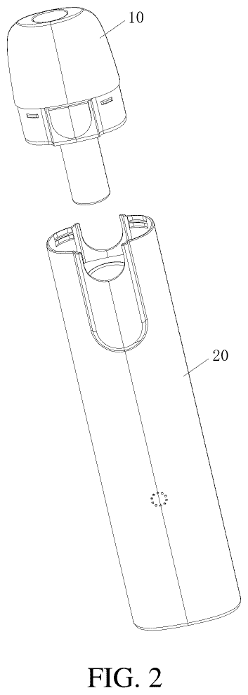

As shown in FIG. 1 and FIG. 2, an electronic atomization device 100 includes an atomizer 10 and a power supply assembly 20.

The atomizer 10 is detachably or removably connected to the power supply assembly 20, including but not limited to a snap fit connection, a magnetic connection, and a threaded connection.

In a preferred implementation, an outer surface of the atomizer 10 is provided with a bump. An inner surface of the power supply assembly 20 is provided with a groove. The snap fit connection between the atomizer 10 and the power supply assembly 20 is implemented through cooperation between the bump and the groove.

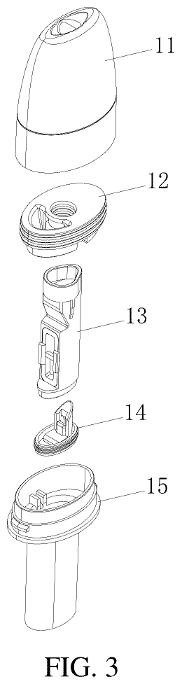

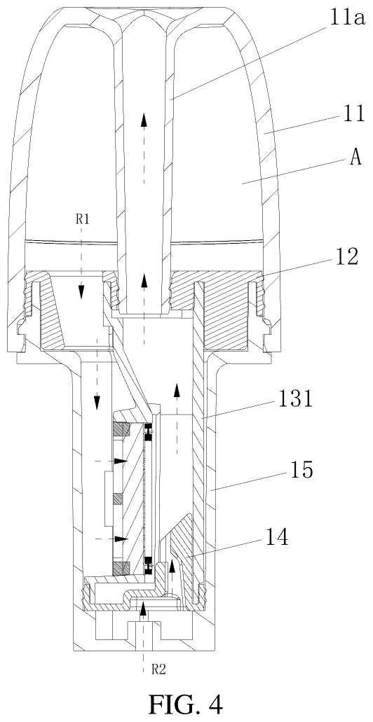

As shown in FIG. 3 to FIG. 4, the atomizer 10 includes an upper housing 11, a seal member 12, an atomization assembly 13, a seal member 14, and a bottom base 15.

The upper housing 11 has a mouth piece end and an open end. The mouth piece end is provided with a mouth piece port or an air outlet, and an atomized aerosol can be inhaled by a user or a smoker through the mouth piece port. An integrally formed conveying tube 11a is further arranged inside the upper housing 11 and is configured to guide an aerosol to the mouth piece port. An upper end of the conveying tube 11a is communicated with the mouth piece port, and a lower end of the conveying tube 11a extends into the atomization assembly 13. In another example, it is also feasible that the conveying tube 11a is formed by a single hollow tube.

A liquid storage cavity A is configured to store a liquid substrate capable of generating an aerosol. The liquid storage cavity A is at least partially defined by an inner surface of the upper housing 11, an outer surface of the atomization assembly 13, and an inner surface of the bottom base 15.

The liquid substrate preferably includes a tobacco-containing material. The tobacco-containing material includes a volatile tobacco aroma compound released from the liquid substrate when being heated. Alternatively or in addition, the liquid substrate may include a non-tobacco material. The liquid substrate may include water, ethanol or another solvent, plant extracts, nicotine solution, and natural or artificial flavoring agents. Preferably, the liquid substrate further includes an aerosol forming agent. Examples of a suitable aerosol-forming agent are glycerol and propylene glycol.

The seal member 12 is arranged between the conveying tube 11a and the atomization assembly 13, between the atomization assembly 13 and the bottom base 15, and between the bottom base 15 and the upper housing 11, to seal a gap between the conveying tube 11a and the atomization assembly 13, a gap between the atomization assembly 13 and the bottom base 15, and a gap between the bottom base 15 and the upper housing 11. The seal member 12 is made of a flexible material, such as a silicone material. In another example, the seal member 12 may include a plurality of separate seal members. For example, one seal member is arranged between the conveying tube 11a and the atomization assembly 13, and another seal member is arranged between the bottom base 15 and the upper housing 11. In another example, it is also feasible that the seal member 12 and the bottom base 15 (or the upper housing 11) are integrally formed. For example, they are integrally formed through double-shot molding. In another example, it is also feasible that the seal member 12 is not arranged.

In a further implementation, an air pressure balance channel may be arranged in the seal member 12, and/or between the seal member 12 and the conveying tube 11a, and/or between the seal member 12 and the upper housing 11, and/or between the conveying tube 11a and the atomization assembly 13, and/or between the bottom base 15 and the upper housing 11, to supplement the liquid storage cavity A with gas to balance air pressures within and outside the liquid storage cavity A, thereby facilitating conveying of the liquid substrate.

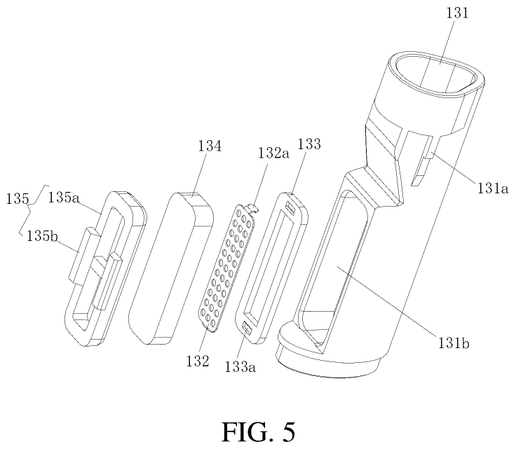

As shown in FIG. 5, the atomization assembly 13 includes a support 131, a heating element 132, a heat insulation member 133, a liquid transfer unit 134, and a holder 135.

The support 131 is constructed as a tubular structure with openings in two ends, a cross section of which may be a circle, an ellipse, a square, a track shape, or an annulus, or in another shape. An upper end of the support 131 extends toward the conveying tube 11a, and a lower end of the conveying tube 11a extends into the support 131 through an opening of the upper end of the support 131. A lower end of the support 131 is accommodated or held in a second connection part 152 of the bottom base 15, and an opening of the lower end of the support 131 is communicated with an air inlet 152b.

In a further implementation, a positioning part 131a extending radially outward is arranged on an outer surface of the support 131 close to the upper end, and an inner surface of a first connection part 151 of the bottom base 15 has a groove 151a. It is convenient to assemble the support 131 into the bottom base 15 through cooperation between the positioning part 131a and the groove 151a.

In a further implementation, a supporting part 152a is arranged in the second connection part 152 of the bottom base 15, and the lower end of the support 131 is abutted with the supporting part 152a. In this way, when the support 131 is assembled into the bottom base 15, the support 131 may be supported through the supporting part 152a. In a preferred implementation, the supporting part 152a includes a plurality of bumps spaced apart from each other. The plurality of bumps extend longitudinally and protrude out of an inner surface of the second connection part 152.

A side wall of the support 131 has a liquid inlet 131b. An accommodating cavity communicated with the liquid inlet 131b and an airflow channel communicated with the accommodating cavity are formed in the support 131. It can be seen from FIG. 4 that a part of a liquid storage cavity A defined and formed between the inner surface of the second connection part 152 and an outer surface of the support 131, the accommodating cavity, and the airflow channel are sequentially arranged in the width direction of the housing assembly. This part of the liquid storage cavity A and the airflow channel are located on two sides of the heating element 132. A part of a surface of the liquid transfer unit 134 defines a boundary of this part of the liquid storage cavity A, and a part of a surface of the heating element 132 defines a boundary of the airflow channel. In this way, on the one hand, a volume of the liquid storage cavity A is enlarged, and on the other hand, the liquid substrate can be smoothly transferred to the heating element 132 through the liquid inlet 131b. Air flows in from the opening of the lower end of the support 131 and flows out from the opening of the upper end of the support 131 to the conveying tube 11a through the airflow channel. That is, the opening of the lower end of the support 131 defines an air inlet, and the opening of the upper end of the support 131 defines an air outlet.

The heating element 132 is configured as a sensor that is inductively coupled to a magnetic field generator 26 and that generates heat under penetration of a changing magnetic field to heating the liquid substrate, thus generating an aerosol for inhalation. The heating element 132 may be made of at least one of the following materials: aluminum, iron, nickel, copper, bronze, cobalt, ordinary carbon steel, stainless steel, ferritic stainless steel, martensitic stainless steel, or Austenitic stainless steel.

The heating element 132 is assembled in the support 131 through the liquid inlet 131b, and is accommodated in the accommodating cavity. The heating element 132 and the liquid transfer unit 134 are arranged to extend in a longitudinal direction of the support 131. The heating element 132 is platy. The platy heating element 132 has a plurality of holes. There is no limitation on a quantity and shapes of the holes. A surface of the heating element 132 is communicated with the liquid storage cavity A through the liquid inlet 131b, that is, the liquid substrate stored in the liquid storage cavity A can flow into the heating element 132 through the liquid inlet 131b. At least a part of the airflow channel is defined between another opposite surface of the heating element 132 and an inner surface of the support 131. The holes penetrate through the two surfaces of the heating element 132.

The heat insulation member 133 is also assembled into the support 131 through the liquid inlet 131b, and is accommodated in the accommodating cavity. At least a part of the heat insulation member 133 is arranged between the support 131 and the heating element 132, to separate the support 131 from the heating element 132, thereby preventing a problem of heat loss caused by excessive heat of the heating element 132 being transmitted to the support 131. The heat insulation member 133 may be made of a flexible material, for example, a high-temperature-resistant silicone material. In this way, a gap between the inner surface of the support 131 and the heating element 132 may alternatively be sealed through a flexible sealing property of the silicone material.

In a preferred implementation, the heat insulation member 133 is configured to be in a track shape surrounding a through hole (a window). A clamping hole 133a is provided in the heat insulation member 133, and one end of the heating element 132 has a fastener 132a protruding out of the heat insulation member 133. In this way, the heating element 132 may be maintained on one surface of the heat insulation member 133 through snap fit between the fastener 132a and the clamping hole 133a, and the other opposite surface of the heat insulation member 133 is in contact with a limiting portion 131c in the support 131. The limiting portion includes a bump protruding out of the inner surface of the support 131. After the heating element 132 is in snap fit connection with the heat insulation member 133, a part of a surface close to an edge of the heating element 132 is in contact with the heat insulation member 133, and the holes of the heating element 132 are exposed through a through hole of the heat insulation member 133, namely, exposed in the airflow channel, so that an aerosol generated by atomization can escape into the airflow channel. In this way, during assembling, the heating element 132 and the heat insulation member 133 may be assembled into the support 131 through the liquid inlet 131b.

The liquid transfer unit 134 is configured to: extract the liquid substrate in the liquid storage cavity A and transfer the extracted liquid substrate to the heating element 132. The liquid transfer unit 134 may be made of a natural or artificial fiber material, for example, a natural cotton fiber, a glass fiber, sponge, or a non-woven fabric. The liquid transfer unit 134 is also approximately platy. One surface of the liquid transfer unit 134 is in contact with a surface of the heating element 132, and another opposite surface is communicated with the liquid storage cavity A.

The holder 135 is arranged at the liquid inlet 131b. The holder 135 is also configured to be in a shape of a track surrounding the through hole. The holder 135 is connected to the support 131. The holder 135 includes a body 135a and a lug 135b arranged on the body 135a. The body 135a is assembled into the support 131 through the liquid inlet 131b. The lug 135b is exposed on a side wall of the support 131. The lug 135b protrudes out in a width direction or a length direction of the body 135a, so as to be abutted with the side wall of the support 131. The liquid transfer unit 134 may be held between the liquid inlet 131b and the heating element 132 through the holder 135 and is in contact with a surface of the heating element 132, that is, is abutted with the heating element 132.

During assembling, the heating element 132 may be first in snap in connection with the heat insulation member 133, and then the heating element 132 and the heat insulation member 133 are assembled together into the support 131 through the liquid inlet 131b. Afterwards, the liquid transfer unit 134 is assembled in the support 131 through the liquid inlet 131b. Finally, the holder 135 is arranged at the liquid inlet 131b, and the holder 135 presses the liquid transfer unit 134, so that a surface of the liquid transfer unit 134 is in good contact with a surface of the heating element 132.

The liquid substrate stored in the liquid storage cavity A may be extracted by the liquid transfer unit 134 through the holder 135 and transferred to the heating element 132 (as shown by R1 in FIG. 4). The aerosol generated by atomization by the heating element 132 may escape into the support 131 or the airflow channel through the holes of the heating element 132 and the through hole of the heat insulation member 133. After being mixed with external air, the aerosol flows into the conveying tube 11a, and may be inhaled by a user or a smoker through the mouth piece port (as shown by R2 in FIG. 4).

The seal member 14 is configured to seal a gap between the support 131 and the second connection part 152 of the bottom base 15. Similar to the seal member 12, the seal member 14 is made of a flexible material, such as a silicone material. For another structural design, refer to the seal member 12.

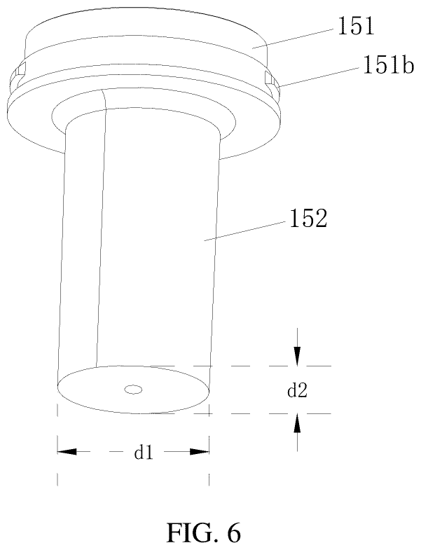

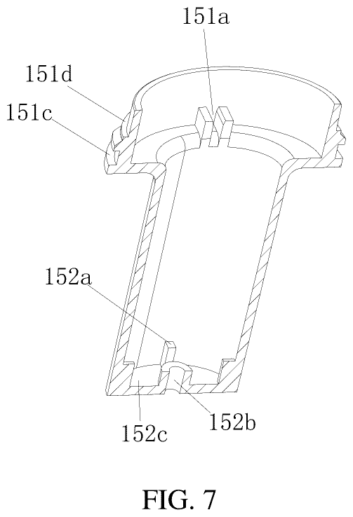

As shown in FIG. 6 to FIG. 7, the bottom base 15 and the upper housing 11 form a housing assembly of the atomizer 10. The bottom base 15 includes the first connection part 151 and the second connection part 152 that are integrally formed. In another example, it is also feasible that the first connection part 151 and the second connection part 152 are separately formed.

The first connection part 151 is accommodated in the upper housing 11. A cross section of the first connection part 151 is substantially in a shape of an ellipse. An area of an opening in an upper end of the first connection part 151 is larger than an area of an opening in a lower end of the first connection part 151, and the opening in the lower end is close to the second connection part 152 or defines the opening in the upper end of the second connection part 152.

In a preferred implementation, a bump 151b is arranged on an outer surface of the first connection part 151, and a groove (not shown) is provided in the inner surface of the upper housing 11. The snap fit connection between the first connection part 151 and the upper housing 11 is implemented through cooperation between the bump 151b and the groove.

In a preferred implementation, the lower end of the first connection part 151 has a supporting part 151c extending radially outward to support an end portion of an open end of the upper housing 11. A step 151d is further arranged on the outer surface of the first connection part 151 close to the upper end. A part of the seal member 12 is held on the step 151d.

The second connection part 152 is exposed out of the upper housing 11 or the atomizer 10. In this way, the upper housing 11 constitutes a first part of the housing assembly of the atomizer 10, and the second connection part 152 constitutes a second part of the housing assembly of the atomizer 10. A radial size of the second part is less than a radial size of the first part.

The second connection part 152 is constructed in a shape of a sleeve, and has a radial size less than or equal to 9 mm. The radial size of the second connection part 152 is less than a radial size of the first connection part 151. For example, a size of a cross section of the second connection part 152 in the width direction is less than a size of the first connection part 151 in the width direction, a size of the cross section of the second connection part 152 in the length direction is less than a size of the first connection part 151 in the length direction, a size of an outer diameter of the cross section of the second connection part 152 is less than a size of an outer diameter of the first connection part 151, or a cross-sectional area of the first connection part 151 is greater than a cross-sectional area of the second connection part 152, and a length dimension of the second connection part 152 extending in the longitudinal direction is greater than a length dimension of the first connection part 151.

In a preferred implementation, the cross section of the second connection part 152 is in a shape of an ellipse, and the radial size of the second connection part 152 is a size of a major axis or a minor axis of the ellipse. A difference between the major axis and the minor axis of the second connection part 152 is between 0.5 mm and 2 mm (preferably, between 0.5 mm and 1.5 mm; further preferably, between 0.5 mm and 1 mm). Specifically, a length of a major axis d1 of the ellipse is between 8 mm and 9 mm (preferably, between 8 mm and 8.8 mm; further preferably, between 8 mm and 8.6 mm; further preferably, between 8.2 mm and 8.6 mm; further preferably, between 8.4 mm and 8.6 mm). A length of a minor axis d2 of the ellipse is between 6 mm and 8 mm (preferably, between 7 mm and 8 mm; further preferably, between 7.2 mm and 8 mm; further preferably, between 7.4 mm and 8 mm; further preferably, between 7.6 mm and 8 mm; further preferably, between 7.6 mm and 7.8 mm). In a specific embodiment, the length of the major axis d1 is 8.5 mm, and the length of the minor axis d2 is 7.7 mm.

In another example, the cross section of the second connection part 152 may alternatively be in a shape of a circle. The radial size of the second connection part 152 is a diameter of the circle.

The air inlet 152b is provided in a bottom end of the second connection part 152. A wall on which the air inlet 152b is formed protrudes out of the bottom end of the second connection part 152, to prevent the liquid substrate collected in a collecting cavity 152c from directly flowing to the power supply assembly 20 through the air inlet 152b. External air flows in through the air inlet 152b, successively passes through the seal member 14, the support 131, and the conveying tube 11a, and flows out from the air outlet of the upper housing 11.

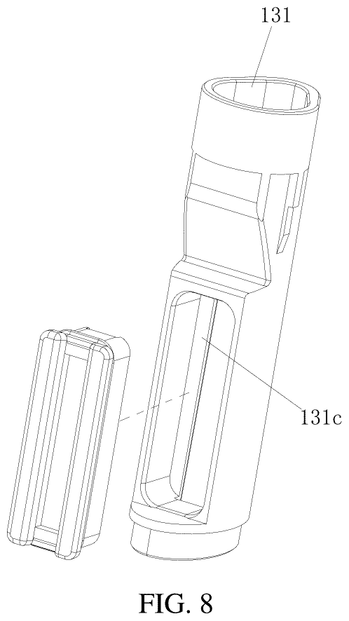

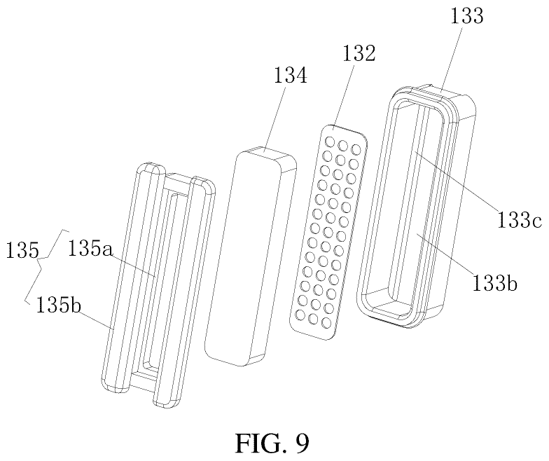

FIG. 8 to FIG. 9 show another atomization assembly of the present application. Different from the example shown in FIG. 2 to FIG. 7, the heat insulation member 133 is configured to be of a cavity structure with openings in two ends. An opening in one end of the heat insulation member 133 is communicated with the liquid inlet 131b, and an opening in the other end of the heat insulation member 133 is communicated with the airflow channel. An inner hollow part 133b of the heat insulation member 133 is configured to accommodate the heating element 132, the liquid transfer unit 134, and the body 135a of the holder 135, and may be assembled into the inner hollow part 133b of the heat insulation member 133 through one end of the heat insulation member 133 close to the liquid inlet 131b. The body 135a of the holder 135 may hold the heating element 132 and the liquid transfer unit 134 inside the heat insulation member 133, and the lug 135b of the holder 135 is exposed out of the heat insulation member 133. One end of the heat insulation member 133 close to the airflow channel further has a limiting portion 133c. The limiting portion 133c is abutted with one surface of the heating element 132 to limit movement of the heating element 132 toward the airflow channel.

During assembling, the heating element 132, the liquid transfer unit 134, and the holder 135 may be first assembled to the heat insulation member 133 to form an integral module, and then the module is assembled to the support 131 through the liquid inlet 131b. After the assembling, the lug 135b of the holder 135 is still exposed out of and abutted with the side wall of the support 131. Compared with the example shown in FIG. 2 to FIG. 7, it is more convenient to assemble the another atomization assembly shown in FIG. 8 to FIG. 9. The aerosol generated by atomization by the heating element 132 overflows into the airflow channel through the opening in the end of the heat insulation member 133 close to the airflow channel.

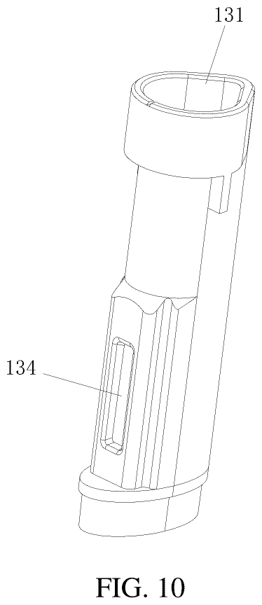

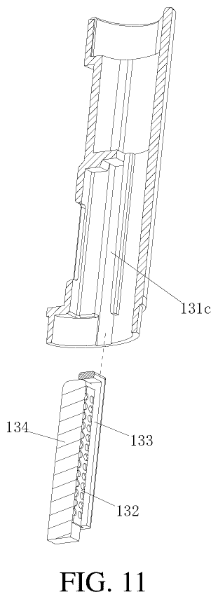

FIG. 10 to FIG. 12 show still another atomization assembly of the present application. Different from the example shown in FIG. 2 to FIG. 7, the atomization assembly 13 is not provided with the holder 135. The heating element 132, the heat insulation member 133, and the liquid transfer unit 134 are assembled in the support 131 through the opening in the lower end of the support 131. Specifically:

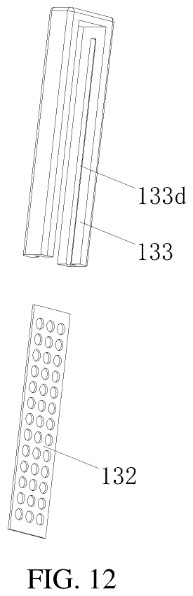

Similar to the example shown in FIG. 8 to FIG. 9, the heat insulation member 133 is configured to be of a cavity structure with openings in two ends. A difference is that a side wall of the heat insulation member 133 has an assembling port (not shown). As shown in FIG. 12, an inner surface of the heat insulation member 133 has two opposite clamping slots 133d. The heating element 132 may be assembled into the heat insulation member 133 along the clamping slots 133d through the assembling port on the side wall of the heat insulation member 133. Through the clamping slots 133d, two opposite ends of the heating element 132 in a width direction may be clamped or held. Similarly, the limiting portion 131c in the support 131 is configured to be of a groove structure. The assembled heating element 132 and heat insulation member 133 may be assembled into the support 131 along the limiting portion 131c through the opening in the lower end of the support 131. Two opposite ends of the heat insulation member 133 in a width direction may be held through the limiting portion 131c. One surface of the liquid transfer unit 134 is in contact with the heating element 132, and another opposite surface is communicated with the liquid storage cavity A through the liquid inlet 131b. The liquid transfer unit 134 is also assembled into the support 131 through the opening in the lower end of the support 131. It may be understood that the liquid transfer unit 134 may be assembled into the support 131 together with the heating element 132 and the heat insulation member 133. For example: Two opposite ends of the liquid transfer unit 134 in a width direction are sandwiched in the heat insulation member 133, and then are assembled into the support 131 together with the heating element 132 and the heat insulation member 133.

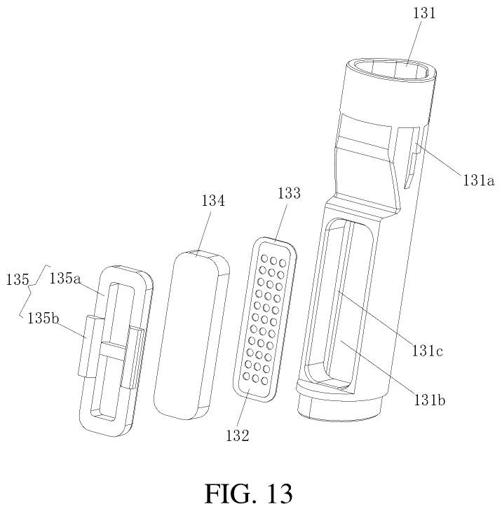

FIG. 13 shows a still yet another atomization assembly according to the present application. Different from the example shown in FIG. 2 to FIG. 7, the heat insulation member 133 and the heating element 132 are integrally formed, and may be integrally formed through soldering, crimping, or the like. The heat insulation member 133 is arranged along a peripheral edge of the heating element 132 and surrounds the heating element 132. The heat insulation member 133 is made of a non-ferromagnetic material. Under penetration of a changing magnetic field, the non-ferromagnetic material does not generate heat or heat generated by the heat insulation member is much less than heat generated by the heating element 132. The heat generated by the heat insulation member 133 is less than the heat generated by the heating element 132 by an order of magnitude. The non-ferromagnetic material includes, but is not limited to, Austenitic stainless steel, aluminum, copper, gold, silver, lithium, and magnesium.

During assembling, the heating element 132 is abutted with the limiting portion 131c of the support 131 through the heat insulation member 133. Afterwards, the liquid transfer unit 134 is assembled in the support 131 through the liquid inlet 131b. Finally, the holder 135 is arranged at the liquid inlet 131b, and the holder 135 presses the liquid transfer unit 134, so that a surface of the liquid transfer unit 134 is in good contact with a surface of the heating element 132.

It should be noted that, the above heating element 132 is not limited to a heating element with electromagnetic induction. In another example, it may be a common heating element with resistive heating, ultrasonic atomization, infrared heating, or the like.

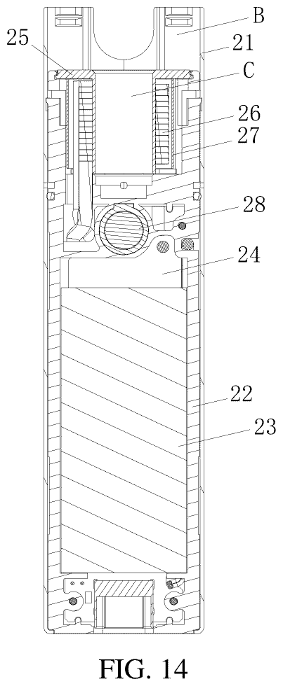

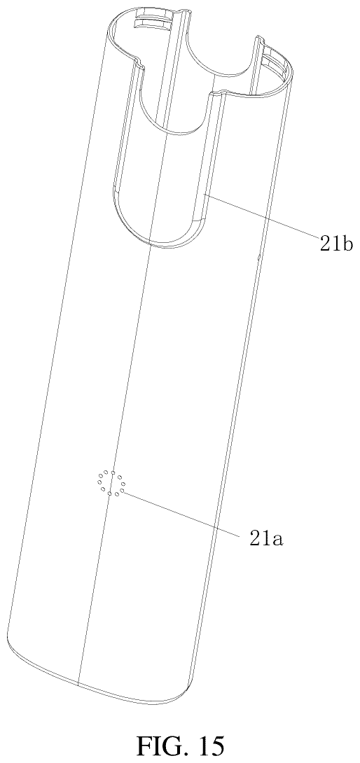

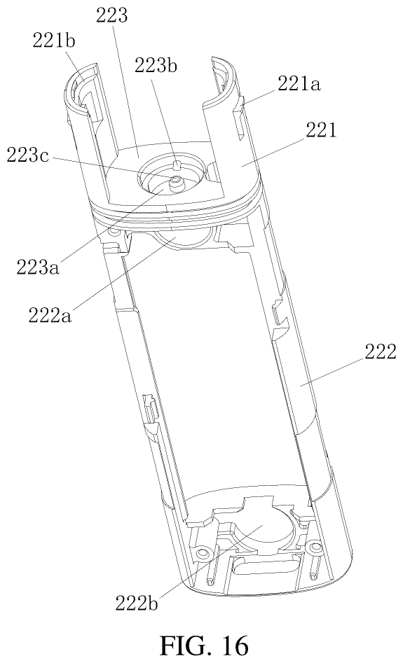

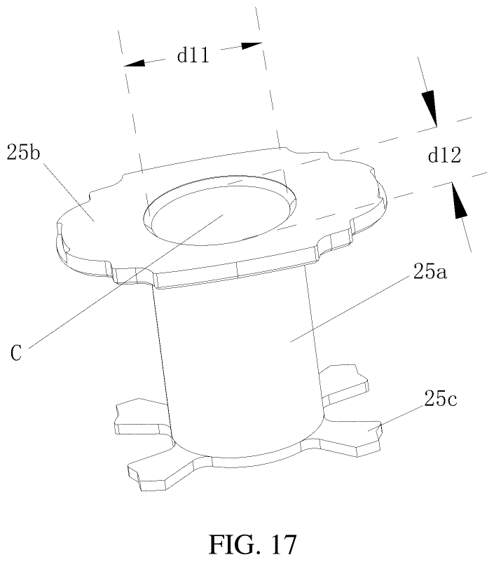

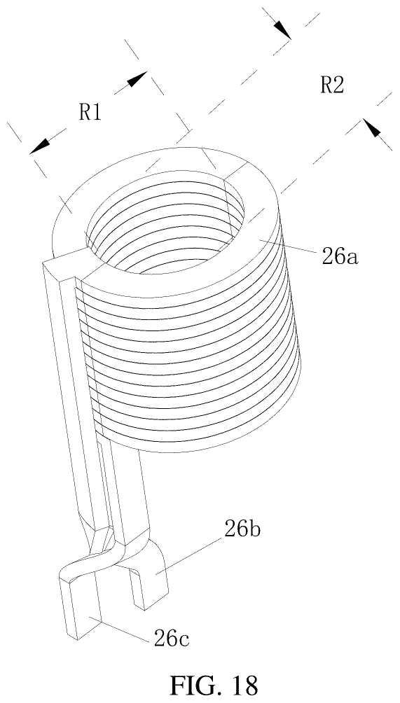

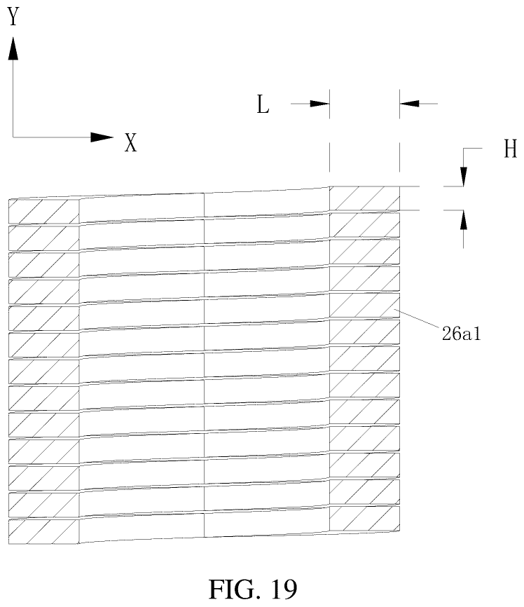

As shown in FIG. 14 to FIG. 19, the power supply assembly 20 includes a lower housing 21, a lower support 22, a battery cell 23, a circuit 24, a base 25, a magnetic field generator 26, a shielding member 27, and a sensor 28.

The lower housing 21 is of a cylindrical structure having openings in two ends. The lower housing 21 and the upper housing 11 define a housing of an electronic atomization device 100.

An airflow inlet 21a is provided in an outer surface of the lower housing 21. External air may flow into the lower housing 21 through the airflow inlet 21a. A part of an outer surface of front and rear sides of the lower housing 21 protrudes to form a protruding portion 21b (or a part of an inner surface of the front and rear sides of the lower housing 21 is recessed to form the protruding portion 21b on the outer surface of the lower housing 21). Through the protruding portion 21b, a size of a part of the electronic atomization device 100 in a thickness direction may be increased, and then a magnetic field generator 26 with a larger size may be accommodated, for example, an induction coil.

The lower support 22 includes an accommodating portion 221 and a mounting portion 222. The accommodating portion 221 and the mounting portion 222 are separated by a separating plate 223.

The lower support 22 is accommodated in the lower housing 21. A size of the lower support 22 in a length direction is less than a size of the lower housing 21 in a length direction. A receiving part B is formed between an upper end of the lower support 22 and an upper end of the lower housing 21 or between the lower support 22 and an inner surface of the lower housing 21, and a lower end of the lower support 22 abuts against an end portion of a lower end of the lower housing 21. After assembly, a part of the upper housing 11 is received in the receiving part B.

An outer surface of the accommodating portion 221 is provided with a cantilever 221a. The cantilever 221a is in snap fit connection with a groove on the inner surface of the lower housing 21. An inner surface of the accommodating portion 221 is provided with a step 221b. A body portion 25a of the base 25 is accommodated in the accommodating portion 221. An extension portion 25b of the base 25 abuts against the step 221b, and a plurality of extension portions 25c of the base 25 are abutted with the separating plate 223.

A component may be mounted to the front and rear of the mounting portion 222. In this example, the battery cell 23 is mounted to the front of the mounting portion 222, and the circuit 24 is mounted to the rear of the mounting portion 222. To be specific, the components are successively arranged in the thickness direction of the electronic atomization device 100. An accommodating chamber 222a and an accommodating chamber 222b are further arranged in the mounting portion 222. The accommodating chamber 222a is configured to accommodate the sensor 28. The accommodating chamber 222b is configured to accommodate a motor (not shown). The motor generates a prompt signal to prompt a user. Specific prompt information is not limited herein.

A groove 223a is provided on the separating plate 223. The groove 223a is coaxial with a receiving part C. An airflow inlet 223b is provided in the groove 223a. Air may flow into the groove 223a through the airflow inlet 223b, and then flow into an atomizer 10 through the air inlet 152b of the bottom base 15. An induction channel 223c is further provided in the groove 223a. The induction channel 223c is communicated with the accommodating chamber 222a.

The battery cell 23 is configured to provide electric power for operating the electronic atomization device 100. The battery cell 23 may be a rechargeable battery cell or a disposable battery cell.

The circuit 24 may control overall operations of the electronic atomization device 100. The circuit 24 not only controls operations of the battery cell 23 and the magnetic field generator 26, but also controls an operation of another element in the electronic atomization device 100. The circuit 24 includes at least one processor. The processor may include a logic gate array, or may include a combination of a general-purpose microprocessor and a memory that stores programs executable in the microprocessor. In addition, a person skilled in the art should understand that the circuit 24 may include another type of hardware.

The base 25 includes the body portion 25a, and an inner hollow part thereof defines or forms at least a part of the receiving part C. An extension portion 25b are arranged on an upper end of the body portion 25a, and a plurality of extension portions 25c are arranged on a lower end. After the assembling, the second connection part 152 of the bottom base 15 is at least partially received in the receiving part C. A radial size of the receiving part C is between 7 mm and 20 mm.

In a preferred implementation, a cross section of the body portion 25a is in a shape of an ellipse. To be specific, the receiving part C is in a shape of an ellipse. The radial size of the receiving part C is a size of a major axis or a minor axis of the ellipse. A difference between the major axis and the minor axis of the receiving part C is between 0.5 mm and 2 mm (preferably, between 0.5 mm and 1.5 mm; further preferably, between 0.5 mm and 1 mm). The receiving part C is in the shape of the ellipse, which is beneficial to the overall flat shape of the electronic atomization device 100, thereby improving aesthetics of the electronic atomization device 100. Specifically, a length of a major axis d11 of the ellipse is between 7 mm to 10 mm (preferably, between 7 mm and 9 mm; further preferably, between 7.5 mm and 9 mm; further preferably, between 8 mm and 9 mm; further preferably, between 8.5 mm and 9 mm). A length of a minor axis d12 of the ellipse is between 7 mm and 9 mm (preferably, between 7 mm and 8.5 mm; further preferably, between 7 mm and 8.3 mm; further preferably, between 7 mm and 8.1 mm; further preferably, between 7.5 mm and 8.1 mm; further preferably, between 7.7 mm and 8.1 mm; further preferably, between 7.9 mm and 8.1 mm). In a specific embodiment, the length of the major axis d11 is 8.8 mm, and the length of the minor axis d12 is 8 mm.

The magnetic field generator 26 is configured to generate a variable magnetic field under an alternating current. The magnetic field generator 26 includes, but is not limited to, an induction coil. The magnetic field generator 26 is arranged close to the receiving part C. The magnetic field generator 26 at least partially surrounds the receiving part C. The body portion 26a of the magnetic field generator 26 is sleeved outside the body portion 25a of the base 25. An electrical connection part 26b and an electrical connection part 26c of the magnetic field generator 26 are configured to be electrically connected to the battery cell 23. When the second connection part 152 of the bottom base 15 is at least partially received in the receiving part C, the heating element 132 is completely located in the receiving part C, so that a magnetic field generated by the magnetic field generator 26 can substantially cover the heating element 132. In this way, a coupling distance between the heating element 132 and the magnetic field generator 26 is reduced, thereby improving heating efficiency of the atomizer 10. In a preferred implementation, when the second connection part 152 of the bottom base 15 is at least partially received in the receiving part C, the heating element 132 and the magnetic field generator 26 are coaxial and both extend in an axial direction of the electronic atomization device 100, which is conductive to improving the heating efficiency of the atomizer 10. An extension length of the magnetic field generator 26 in the axial direction is greater than an extension length of the heating element 132 in the axial direction.

The body portion 26a of the magnetic field generator 26 is a solenoidal coil wound by a relatively long wire material. For example: it is formed by coiling 1600 to 1900 wires with a size of 0.02 mm, or may be formed by coiling 750 to 1050 wires with a size of 0.03 mm. A number of turns or windings of the solenoidal coil is between 6 to 20; preferably, between 6 to 15; further preferably, between 6 to 12; further preferably, between 6 to 10. A spacing between adjacent windings is approximately between 0.1 mm and 0.5 mm. In a specific embodiment, a spacing between adjacent windings is between 0.2 mm and 0.4 mm. The spacing between adjacent windings may be the same or different.

A cross section of a wire material may have a rectangular shape, a circular shape, or the like.

In a preferred implementation, a cross section of a wire material has a first side extending in a radial direction X of the magnetic field generator 26 and a second side extending in an axial direction Y of the magnetic field generator 26. The cross section of the wire material is substantially rectangular. A size L of the first side is greater than a size H of the second side, so that the wire material of the magnetic field generator 26 has a flat structure, which is conductive to increasing the number of turns of the magnetic field generator 26 per unit length and then increasing an inductance value. In addition, the second side is arranged against a wall of the receiving part C, that is, against the outer surface of the body portion 25a of the base 25. Alternatively, the number of turns of the magnetic field generator 26 may be increased within a limited height space.

In a preferred implementation, a ratio of the size L of the first side to the size H of the second side is between 1.5-3; preferably, between 2 and 3; and further preferably, between 2.5 and 3. For example, in a specific embodiment, the ratio of the size L of the first side to the size H of the second side is 2.8.

In a preferred implementation, the size L of the first side is approximately between 1-5 mm, and the size H of the second side is approximately between 0.3-1 mm. For example, in a specific embodiment, the size L of the first side is 2.5 mm, and the size H of the second side is 0.9 mm.

In a preferred implementation, a total length of the body portion 26a of the magnetic field generator 26 along the axial direction Y is approximately between 5 mm and 20 mm. In a specific embodiment, a total length of the body portion 26a of the magnetic field generator 26 along the axial direction Y is 12.2 mm.

A cross section of the hollow part of the body portion 26a of the magnetic field generator 26 may be circular or elliptical.

In a preferred implementation, a cross section of a hollow part of the body portion 26a of the magnetic field generator 26 is non-circular. For example, the cross section is elliptical or oval or track-shaped. In some examples, a difference between the major axis and the minor axis of the ellipse is between 0.5 mm to 2 mm. Specifically, a length of a major axis R1 of the ellipse is between 8 mm to 15 mm (preferably, between 8 mm and 12 mm; further preferably, between 8 mm and 10 mm; further preferably, between 9 mm and 10 mm). A length of a minor axis R2 of the ellipse is between 8 mm to 13 mm (preferably, between 8 mm and 11 mm; further preferably, between 8 mm and 10 mm; further preferably, between 8 mm and 9 mm). In a specific embodiment, the length of the major axis R1 of the ellipse is 9.7 mm, and the length of the minor axis R2 of the ellipse is 8.9 mm.

The shielding member 27 is arranged around or sleeved outside the body portion 26a of the magnetic field generator 26. The shielding member 27 is configured to shield the magnetic field emitted from the magnetic field generator 26 substantially along the radial direction, to prevent the emitted magnetic field from affecting another component.

The sensor 28 is configured to sense a change in airflow in the groove 223a through the induction channel 223c, that is, detect inhalation of the user, to generate a signal to control the atomizer 10 to start operating.

It should be noted that, the specification of the present application and the drawings thereof provide preferred embodiments of the present application. However, the present application may be implemented in various different forms, and is not limited to the embodiments described in this specification. These embodiments are not used as an additional limitation on the content of the present application, and are described for providing a more thorough and comprehensive understanding of the content disclosed in the present application. Moreover, various embodiments not listed above formed by further combining the foregoing technical features with each other are all construed as falling within the scope of the present application. Still further, for a person of ordinary skill in the art, improvements or modifications may be made according to the above descriptions, and all these improvements and modifications shall fall within the protection scope of the appended claims of the present application.

1. An atomization assembly, comprising:
a support, configured to be of a tubular structure having an air inlet and an air outlet, a liquid inlet being provided in a side wall of the support;
a heating element, accommodated inside the support, the heating element comprising a first surface and a second surface opposite to the first surface; the liquid inlet being configured to allow a liquid substrate to flow into the first surface, to cause the heating element to heat the liquid substrate and generate an aerosol; an airflow channel being defined between the second surface and an inner surface of the support, so that air flows in from the air inlet of the support and flows out from the air outlet of the support through the airflow channel; and
a heat insulation member, accommodated inside the support, at least a part of the heat insulation member being arranged between the heating element and the inner surface of the support to separate the heating element from the support.

2. The atomization assembly according to claim 1, wherein the heat insulation member is configured to maintain or support the heating element inside the support.

3. The atomization assembly according to claim 2, wherein the heating element is in snap fit connection to the heat insulation member.

4. The atomization assembly according to claim 3, wherein the heating element is constructed into a sheet and has a plurality of holes penetrating through the first surface and the second surface; the heat insulation member is in contact with the second surface of the heating element and is provided with a window; and the plurality of holes is exposed inside the airflow channel through the window.

5. The atomization assembly according to claim 2, wherein the heat insulation member is configured to be of a cavity structure with openings in two ends; an opening in one end of the heat insulation member is communicated with the liquid inlet, and an opening in the other end of the heat insulation member is communicated with the airflow channel; and
the heating element is accommodated inside the heat insulation member.

6. The atomization assembly according to claim 5, wherein one end of the heat insulation member close to the airflow channel has a first limiting portion, and the first limiting portion is abutted with the second surface.

7. The atomization assembly according to claim 5, wherein an inner surface of the heat insulation member has a clamping slot, and one end of the heating element is clamped in the clamping slot.

8. (canceled)

9. The atomization assembly according to claim 1, wherein the heat insulation member is made of a flexible material, and the heat insulation member is configured to provide sealing between the support and the heating element.

10. The atomization assembly according to claim 1, wherein the heat insulation member and the heating element are together assembled into the support from the air inlet or the liquid inlet of the support.

11. The atomization assembly according to claim 1, wherein the heating element is configured to be a sensor capable of generating heat under penetration of a changing magnetic field.

12-14. (canceled)

15. The atomization assembly according to claim 1, wherein the atomization assembly further comprises a liquid transfer unit accommodated inside the support; and the liquid transfer unit is arranged between the liquid inlet and the first surface and is in contact with the first surface, to extract the liquid substrate flowing in from the liquid inlet and transfer the extracted liquid substrate to the first surface.

16. The atomization assembly according to claim 15, wherein the atomization assembly further comprises a holder connected to the support and configured to abut the liquid transfer unit with the first surface of the heating element.

17. The atomization assembly according to claim 1, wherein a second limiting portion is arranged in the support, and the second limiting portion is abutted with the heat insulation member to limit movement of the heat insulation member toward the airflow channel.

18. The atomization assembly according to claim 1, wherein the heating element is constructed into a sheet and has a plurality of holes penetrating through the first surface and the second surface, and the holes allow the aerosol to escape into the airflow channel.

19. The atomization assembly according to claim 1, wherein the heating element is configured to extend in a longitudinal direction of the support.

20. An atomization assembly, comprising:
a support, configured to be of a tubular structure having openings in two ends, a liquid inlet being provided in a side wall of the support, an accommodating cavity communicated with the liquid inlet and an airflow channel communicated with the accommodating cavity being formed in the support, air flowing in from an opening in one end of the support and flowing out from an opening in the other end of the support through the airflow channel;
a heating element, a liquid substrate being able to flow into the heating element through the liquid inlet, to cause the heating element to heat the liquid substrate and generate an aerosol;
a liquid transfer unit, in contact with the heating element, the liquid transfer unit being configured to: extract the liquid substrate flowing in from the liquid inlet and transfer the extracted liquid substrate to the heating element, wherein the heating element is located between the airflow channel and the liquid transfer unit; and
a heat insulation member, configured to hold the heating element and the liquid transfer unit, so as to be assembled into the accommodating cavity together with the heating element and the liquid transfer unit, wherein at least a part of the heat insulation member is arranged between the heating element and an inner surface of the support to provide separation.

21. An atomizer, comprising:
a housing assembly, having a liquid storage cavity for storing a liquid substrate,
the housing assembly comprising a first part and a second part which are longitudinally arranged, a first part liquid storage cavity being defined inside the first part, and a radial size of the second part being less than a radial size of the first part; and,
the atomization assembly according to claim 1, at least a part of the atomization assembly being accommodated in the second part.

22. The atomizer according to claim 21, wherein an outer surface of the support and an inner surface of the second part define a second part liquid storage cavity; and the second part liquid storage cavity and the airflow channel are located on two sides of the heating element and are arranged in a width direction of the housing assembly.

23. An atomizer, comprising:
a housing assembly, having a liquid storage cavity for storing a liquid substrate, the housing assembly comprising a first part and a second part which are longitudinally arranged, a first part liquid storage cavity being defined inside the first part, and a radial size of the second part being less than a radial size of the first part;
a heating element, configured to heat a part of the liquid substrate to generate an aerosol;
a liquid transfer unit, in contact with the heating element, the heating element and the liquid transfer unit being arranged in a longitudinal direction of the housing assembly and dividing the second part to form an airflow channel and a second part liquid storage cavity; and
a support, configured to hold the heating element and the liquid transfer unit inside the second part,
wherein a part of a surface of the liquid transfer unit defines a boundary of the second part liquid storage cavity, and the second part liquid storage cavity is in flow communication with the first part liquid storage cavity; and a part of a surface of the heating element defines a boundary of the airflow channel, and the airflow channel provides a path through which the aerosol flows.

24. (canceled)

25. An electronic atomization device, comprising the atomizer according to claim 21 and a power supply assembly detachably connected to the atomizer, wherein the heating element is configured to generate heat under penetration of a changing magnetic field; and
the power supply assembly comprises:
a receiving part, configured to receive at least a part of the second part; and
a magnetic field generator, configured to generate a changing magnetic field under alternating current, the magnetic field generator is arranged close to the receiving part.
